(19) United States
(12) Patent Application Publication
(10) Pub. No.: US 2026/0292686 A1
(43) Pub. Date: Sep. 24, 2026

(54) LOW POWER COMMUNICATION BETWEEN STRIKE POCKET AND MAIN BOARD OF LOCK TO DETERMINE LOCK STATE

(71) Applicant: Schlage Lock Company LLC, Carmel, IN (US)

(72) Inventors: Arun Handanakere Sheshagiri, Bengaluru (IN); Abhishek Nain, Kaithal (IN)

(21) Appl. No.: 19/082,654

(22) Filed: Mar. 18, 2025

(51) Int. Cl. H04W 52/02; G07C 9/00

(52) U.S. Cl. CPC H04W 52/0235; G07C 9/00182

(57) ABSTRACT

A method of leveraging low power communication to determine a lock state according to an embodiment includes determining a lock state of a first access control device based on sensor data of the first access control device, transmitting a wake-up signal to a second access control device in response to determining a change from a first lock state to a second lock state, waking the second access control device from a low power state, determining a lock state of the first access control device based on sensor data received from the second access control device, transmit a sync signal to the first access control device indicative of the lock state determined by the second access control device, determining whether sync data stored in the first access control device corresponds with the second lock state, and updating the stored sync data to be indicative of the first lock state.

### BACKGROUND

Electronic lock devices and other types of access control devices include a latch or bolt that is configured to extend into a door strike pocket in order to secure the door to the doorframe. Some access control devices include sensors to determine whether the latch or bolt is extended, and then infer the secure, locked status of that access control device. However, those access control devices may convey false positives if the latch or bolt is extended but not securely positioned within the door strike pocket. Accordingly, there is a need for improved technologies to more accurately determine when the latch or bolt is extended into the door strike pocket with limited added power consumption.

### SUMMARY

One embodiment is directed to a unique system, components, and methods for leveraging low power communication within an access control system to determine a lock state. Other embodiments are directed to apparatuses, systems, devices, hardware, methods, and combinations thereof for leveraging low power communication within an access control system to determine a lock state.

According to an embodiment, a method of leveraging low power communication within an access control system to determine a lock state may include determining, by a first access control device, a lock state of the first access control device based on sensor data received from at least one sensor of the first access control device, transmitting, by the first access control device, a wake-up signal to a second access control device in response to determining that the lock state determined by the first access control device is indicative of a change from a first lock state to a second lock state, waking, by the second access control device, a processor of the second access control device from a low power state in response to receiving the wake-up signal from the first access control device, determining, by the processor of the second access control device, a lock state of the first access control device based on sensor data received from at least one sensor of the second access control device, transmit, by the second access control device and to the first access control device, a sync signal that includes data indicative of the lock state determined by the second access control device, determining, by the first access control device, whether sync data stored in a memory of the first access control device corresponds with the second lock state in response to receiving the sync signal, and updating, by the first access control device, the sync data stored in the memory of the first access control device to be indicative of the first lock state in response to determining that the sync data corresponds with the second lock state.

In some embodiments, the at least one sensor of the first access control device may include at least one of a deadbolt monitor or a latch monitor.

In some embodiments, the method may further include placing a processor of the first access control device in a sleep state in response to updating the sync data stored in the memory of the first access control device.

In some embodiments, the method may further include waking the processor of the first access control device from the sleep state in response to determining the sync data stored in the memory of the first access control device corresponds with the second lock state.

In some embodiments, the sync signal may be encoded with the data indicative of the lock state via signal modulation.

In some embodiments, the sync signal may include an on-off keying packet that includes a sync pattern indicative of the lock state determined by the second access control device.

In some embodiments, the first lock state may be an unlocked state and the second lock state is a locked state.

In some embodiments, the first lock state may be a locked state and the second lock state is an unlocked state.

In some embodiments, the at least one sensor of the second access control device may include an inductive sensor.

In some embodiments, the first access control device may include an electronic lock and the second access control device may include a pocket device located at door strike pocket.

In some embodiments, the first access control device may include a latch bolt configured to extend into a door strike to secure a door, and wherein the second access control device may be mechanically coupled with the door strike.

In some embodiments, the second access control device may operate at less than one microamp of current when in the low power state.

According to another embodiment, an access control system for leveraging low power communication to determine a lock state may include a first access control device configured to (i) determine a lock state of the first access control device based on sensor data received from at least one sensor of the first access control device and (ii) transmit a wake-up signal to a second access control device in response to a determination that the lock state determined by the first access control device is indicative of a change from a first lock state to a second lock state, and a second access control device configured to (i) wake a processor of the second access control device from a low power state in response to receipt of the wake-up signal from the first access control device, (ii) determine, by the processor of the second access control device, a lock state of the first access control device based on sensor data received from at least one sensor of the second access control device, and (iii) transmit, to the first access control device, a sync signal that includes data indicative of the lock state determined by the second access control device, wherein the first access control device is further configured to (i) determine whether sync data stored in a memory of the first access control device corresponds with the second lock state in response to receipt of the sync signal and (ii) update the sync data stored in the memory of the first access control device to be indicative of the first lock state in response to a determination that the sync data corresponds with the second lock state.

In some embodiments, the at least one sensor of the first access control device may include at least one of a deadbolt monitor or a latch monitor.

In some embodiments, the sync signal may be encoded with the data indicative of the lock state via signal modulation.

In some embodiments, the sync signal may be an on-off keying packet that includes a sync pattern indicative of the lock state determined by the second access control device.

In some embodiments, the first lock state may be an unlocked state and the second lock state may be a locked state.

In some embodiments, the first lock state may be a locked state and the second lock state may be an unlocked state.

In some embodiments, the at least one sensor of the second access control device may include an inductive sensor.

In some embodiments, the first access control device may include a latch bolt configured to extend into a door strike to secure a door, and the second access control device may include mechanically coupled with the door strike.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of an access control system for leveraging low power communication to determine a lock state;

FIG. 2 is a simplified block diagram of at least one embodiment of a computing device;

FIG. 3 is a simplified block diagram of at least one embodiment of a microcontroller capable of performing low power communication;

FIG. 4 is a simplified flow diagram of at least one embodiment of a method of leveraging low power communication within an access control system to determine a lock state; and

FIG. 5 is a simplified diagram of a front view of at least one embodiment of an access control system.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

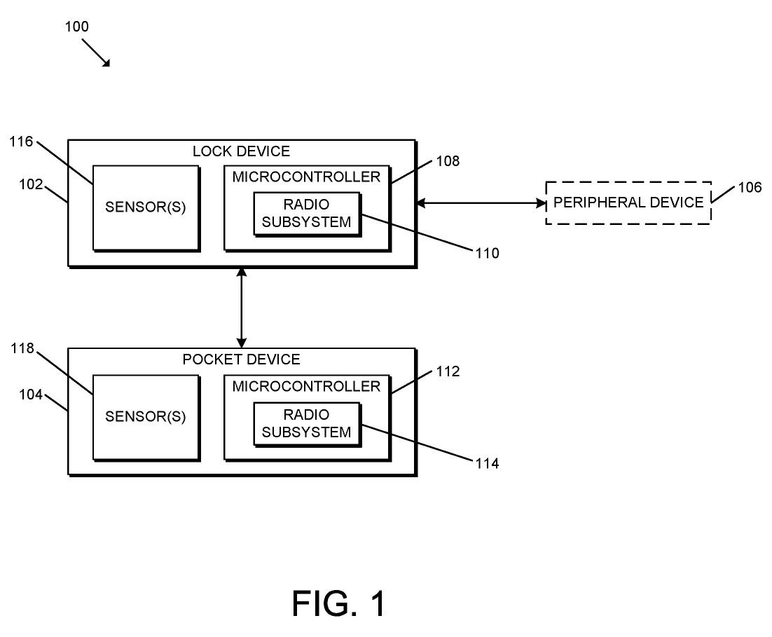

Referring now to FIG. 1, in the illustrative embodiment, an access control system 100 for leveraging low power communication to determine a lock state is shown. The illustrative access control system 100 includes a lock device 102 and a pocket device 104. Further, in some embodiments, the access control system 100 may include a peripheral device 106. As shown, the illustrative lock device 102 includes a microcontroller 108, which includes a radio subsystem 110, and one or more sensors 116, and the illustrative pocket device 104 includes a microcontroller 112, which includes a radio subsystem 114, and one or more sensors 118.

It should be appreciated that the lock device 102, the pocket device 104, and/or the peripheral device 106 may be embodied as any type of device or collection of devices suitable for performing the functions described herein. More specifically, in the illustrative embodiment, the lock device 102 may be embodied as any type of device capable of controlling access through a passageway. For example, in various embodiments, the lock device 102 may be embodied as an electronic lock (e.g., a mortise lock, a cylindrical lock, or a tubular lock) or a peripheral controller of a passageway. In some embodiments, the lock device 102 includes a lock mechanism configured to control access through a passageway. For example, in some embodiments, the lock mechanism may be configured to be positioned in a locked state in which access to the passageway is denied, or positioned in an unlocked state in which access to the passageway is permitted. In some embodiments, the lock mechanism may include a deadbolt, latch bolt, lever, and/or other mechanism adapted to move between the locked and unlocked state and otherwise perform the functions described herein. However, it should be appreciated that the lock mechanism may be embodied as any another mechanism suitable for controlling access through a passageway in other embodiments. In some embodiments, the lock device 102 may include a credential reader or be electrically/communicatively coupled to a credential reader.

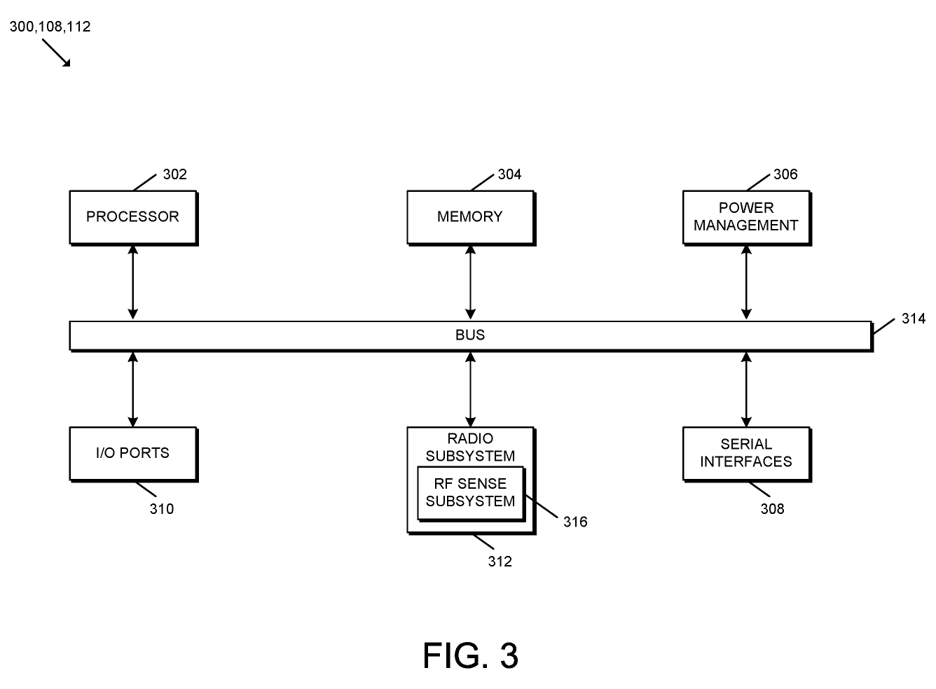

As shown, the illustrative lock device 102 includes a microcontroller 108 and one or more sensors 116. It should be appreciated that the microcontroller 108 may include the radio subsystem 110 and be embodied as any type of device/component capable of executing instructions and otherwise capable of performing the features described herein. For example, the microcontroller 108 may be embodied as an integrated circuit that includes, for example, a central processing unit or processor(s), memory, parallel input and output interfaces, a clock management system, analog-to-digital converters, serial communication interfaces, a power/energy management subsystem, a radio subsystem (e.g., including communication circuitry), timers, triggers, a security system (e.g., for cryptographic processes), and/or other components relevant to performing the features described herein. In some embodiments, the microcontroller 108 may be embodied as a microcontroller similar to the microcontroller 300 of FIG. 3. The radio subsystem 110 may be embodied as any type of communication circuitry capable of generating, transmitting, and receiving signals and otherwise capable of communicating with other devices. It should be appreciated that the communication protocols leveraged by the radio subsystem 110 may vary depending on the particular embodiment (e.g., Bluetooth® (e.g., BLE), Wi-Fi®, WiMAX, cellular, Zigbee, Z-Wave, NFC, Thread, UWB, Matter, etc.). Further, in the illustrative embodiment, the radio subsystem 110 includes a radio frequency (RF) sense system that allows the lock device 102 or portions thereof (e.g., the main processor of the microcontroller 108, other portions of the radio subsystem 110, etc.) to remain in a low power sleep state (e.g., operating at less than one microamp of current), and wake when RF signals/energy are sensed above a specified threshold. As described in further detail herein, the RF sense system is further capable of leveraging on-off keying (OOK) and/or other signal modulation to prevent false wake-up events. For example, in some embodiments, the RF sense system may perform OOK preamble and sync word/pattern detection as described below.

Each of the sensors 116 may be embodied as any type of sensor capable of generating/collecting sensor data indicative of the state of a latch or bolt of the lock device 102. For example, in some embodiments, the sensors 116 may include a deadbolt monitor configured to monitor the location and/or state of a deadbolt of the lock device 102, and/or a latch monitor (e.g., an electrical switch) configured to monitor the location and/or state of a latch of the lock device 102. However, it should be appreciated that the lock device 102 may include additional and/or alternative sensors 116 in other embodiments. Such sensors may detect various characteristics of the physical environment of the lock device 102 (internal and/or external to the lock device 102), electrical characteristics of the lock device 102, electromagnetic characteristics of the lock device 102 or its surroundings, and/or other suitable characteristics. For example, in some embodiments, the lock device 102 may include proximity sensors, optical sensors, light sensors, electromagnetic sensors, hall effect sensors, audio sensors, temperature sensors, motion sensor, piezoelectric sensors, cameras, switches (e.g., reed switches, physical switches, etc.), inductive sensors, capacitive sensors, and/or other types of sensors. Of course, the lock device 102 may also include components and/or devices configured to facilitate the use of such sensors.

The pocket device 104 may be embodied as any type of device capable of being mounted in, secured to, and/or otherwise positioned adjacent a strike pocket for a door lock and otherwise capable of performing the functions described herein. As shown, the illustrative pocket device 104 includes a microcontroller 112 and one or more sensors 118. It should be appreciated that the microcontroller 112 may include the radio subsystem 114 and be embodied as any type of device/component capable of executing instructions and otherwise capable of performing the features described herein. For example, the microcontroller 112 may be embodied as an integrated circuit that includes, for example, a central processing unit or processor(s), memory, parallel input and output interfaces, a clock management system, analog-to-digital converters, serial communication interfaces, a power/energy management subsystem, a radio subsystem (e.g., including communication circuitry), timers, triggers, a security system (e.g., for cryptographic processes), and/or other components relevant to performing the features described herein. In some embodiments, the microcontroller 112 may be embodied as a microcontroller similar to the microcontroller 300 of FIG. 3. The radio subsystem 114 may be embodied as any type of communication circuitry capable of generating, transmitting, and receiving signals and otherwise capable of communicating with other devices. It should be appreciated that the communication protocols leveraged by the radio subsystem 114 may vary depending on the particular embodiment (e.g., Bluetooth® (e.g., BLE), Wi-Fi®, WiMAX, cellular, Zigbee, Z-Wave, NFC, Thread, UWB, Matter, etc.). Further, in the illustrative embodiment, the radio subsystem 114 includes a radio frequency (RF) sense system that allows the pocket device 104 or portions thereof (e.g., the main processor of the microcontroller 112, other portions of the radio subsystem 114, etc.) to remain in a low power sleep state (e.g., operating at less than one microamp of current), and wake when RF signals/energy are sensed above a specified threshold. As described in further detail herein, the RF sense system is further capable of leveraging on-off keying (OOK) and/or other signal modulation to prevent false wake-up events. For example, in some embodiments, the RF sense system may perform OOK preamble and sync word/pattern detection as described below.

Each of the sensors 118 may be embodied as any type of sensor capable of generating/collecting sensor data indicative of the state of a latch or bolt of the lock device 102 within the door strike (e.g., whether the latch/bolt is fully/partially extended into and seated within the door strike). For example, in some embodiments, the sensors 118 may include an inductive sensor. However, it should be appreciated that the pocket device 104 may include additional and/or alternative sensors 118 in other embodiments. Such sensors may detect various characteristics of the physical environment of the lock device 102 and/or pocket device 104, electrical characteristics of the lock device 102 and/or pocket device 104, electromagnetic characteristics of the lock device 102 and/or pocket device 104 or their surroundings, and/or other suitable characteristics. For example, in some embodiments, the pocket device 104 may include proximity sensors, optical sensors, light sensors, electromagnetic sensors, hall effect sensors, audio sensors, temperature sensors, motion sensor, piezoelectric sensors, cameras, switches (e.g., reed switches, physical switches, etc.), inductive sensors, capacitive sensors, and/or other types of sensors. Of course, the pocket device 104 may also include components and/or devices configured to facilitate the use of such sensors.

In some embodiments, the access control system 100 may include a peripheral device 106 in addition to, or alternative to, the pocket device 104. Accordingly, the peripheral device 106 may be embodied as any type of access control device capable of performing the function described herein. It should be appreciated that, in such embodiments, the peripheral device 106 may be configured to perform features similar to the features described below in reference to the pocket device 104.

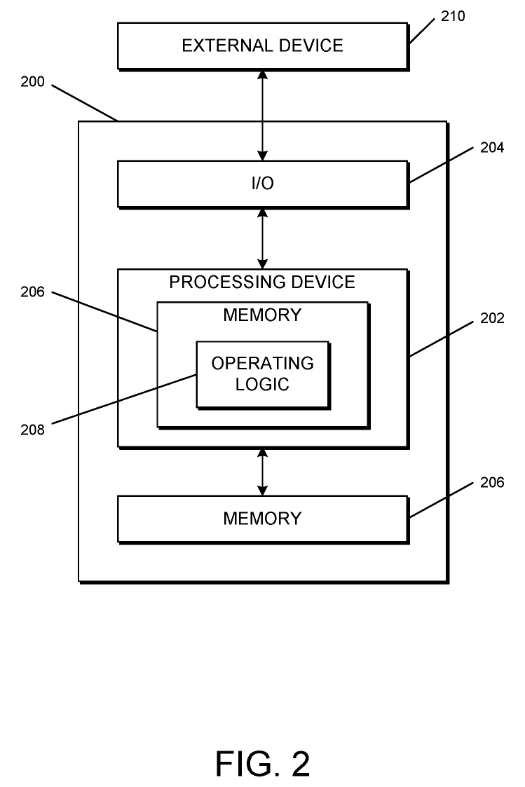

It should be appreciated that each of the lock device 102, the pocket device 104, and/or the peripheral device 106 may be embodied as one or more computing devices similar to the computing device 200 described below in reference to FIG. 2. For example, in the illustrative embodiment, each of the lock device 102, the pocket device 104, and the peripheral device 106 includes a processing device 202 and a memory 206 having stored thereon operating logic 208 for execution by the processing device 202 for operation of the corresponding device.

Although only one lock device 102, one pocket device 104, and one peripheral device 106 are shown in the illustrative embodiment of FIG. 1, the access control system 100 may include multiple lock devices 102, pocket devices 104, and/or peripheral devices 106 in other embodiments.

Referring now to FIG. 2, a simplified block diagram of at least one embodiment of a computing device 200 is shown. The illustrative computing device 200 depicts at least one embodiment of a lock device, pocket device, peripheral device, and/or access control device that may be utilized in connection with the lock device 102, the pocket device 104, and/or the peripheral device 106 illustrated in FIG. 1. Depending on the particular embodiment, computing device 200 may be embodied as a reader device, credential device, access control device, lock device, pocket device, server, desktop computer, laptop computer, tablet computer, notebook, netbook, Ultrabook™, mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, cellular, Zigbee, Z-Wave, NFC, Thread, UWB, Matter, etc.) to bring about such communication depending on the particular computing device 200. The input/output device 204 may include hardware, software, and/or firmware suitable for performing the techniques described herein.

The external device 210 may be any type of device that allows data to be inputted or outputted from the computing device 200. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), Field Programmable Gate Array (FPGA), Complex Programmable Logic Device (CPLD), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is of a programmable variety that executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable variety, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

Referring now to FIG. 3, at least one embodiment of a microcontroller 300 capable of performing low power communication is shown. As indicated above, it should be appreciated that the microcontroller 108 of the lock device 102 and/or the microcontroller 112 of the pocket device 104 may be embodied as a microcontroller similar to the microcontroller 300 of FIG. 3 in some embodiments. FIG. 3 depicts the microcontroller 300 as having a processor 302, a memory 304, a power management 306, one or more serial interfaces 308, one or more input/output (I/O) ports 310, a radio subsystem 312 (which includes an RF sense subsystem 316), and a bus 314 to which those components are electrically/communicatively coupled. It should be appreciated that those components are shown and described for particular emphasis, and the microcontroller 300 may include additional and/or alternative components in various embodiments. For example, the microcontroller 300 may include additional components similar to those described above in reference to the microcontrollers 108, 112.

The processor 302 may be similar to the processing device 202 of FIG. 2. For example, the processor 302 may be embodied as one or more single or multi-core processors, or other processor or processing/controlling circuits. For example, in some embodiments, the processor 302 may include or be embodied as an arithmetic logic unit (ALU), central processing unit (CPU), digital signal processor (DSP), Field Programmable Gate Array (FPGA), Complex Programmable Logic Device (CPLD), and/or another suitable processor(s). The memory 304 may be similar to the memory 206 of FIG. 2. For example, the memory 304 may be of one or more types of non-transitory computer-readable media, such as a solid-state memory, electromagnetic memory, random access memory, flash memory, optical memory, or a combination thereof. Furthermore, the memory 304 may be volatile and/or nonvolatile depending on the particular memory and/or implementation. In operation, the memory 304 may store various data and software used during operation of the microcontroller 300 such as operating systems, applications, programs, libraries, and drivers. In some embodiments, the processor 302 and the memory 304 or a portion thereof may be included on a chipset. It should be appreciated that the memory 304 may include a memory system controller, linked direct memory access controller, and/or other memory systems.

The power management system 306 is configured to manage the power/energy supplied to the microcontroller 300 and/or supplied to the various components of the microcontroller 300. For example, the power management system 306 may include one or more voltage regulators, DC/DC converters, power-on resets, and/or other power/energy-related circuitry. Further, in the illustrative embodiment, the power management system 306 is configured to regulate the power state of the microcontroller 300, components of the microcontroller 300, and/or external devices powered by the microcontroller 300. For example, in the illustrative embodiment, the microcontroller 300 includes a plurality of power states including at least a full power state and a low power sleep state in which the microcontroller 300 consumes less power than when in the full power state. It should be appreciated that the microcontroller 300 may have additional intermediate power states in various embodiments.

The microcontroller 300 may include various serial interfaces 308 and/or I/O ports 310 depending on the particular embodiment. For example, the serial interfaces 308 may include a universal synchronous/asynchronous receiver/transmitter (USART), an enhanced universal asynchronous receiver/transmitting (EUART), an inter-integrated circuit interface, a peripheral reflex system, a pulse density modulation interface, and/or other serial interfaces. Further, the I/O ports 310 may include general purpose input/output (GPIO) pins, a pin reset, a pin wakeup, external interrupts, and/or other types of I/O ports 310.

The radio subsystem 312 may include any types of wireless communication circuitry capable of performing the functions described herein. For example, in the illustrative embodiment, the radio subsystem 312 includes BLE communication circuitry and the associated antenna interface (e.g., for 2.4 GHz communication) and transceiver. It should be appreciated that the radio subsystem 312 may be capable of communicating via other wireless communication protocols in other embodiments. As shown, the illustrative radio subsystem 312 also includes the RF sense subsystem 316, which is capable of leveraging on-off keying (OOK) and/or other signal modulation to prevent false wake-up events. For example, in some embodiments, the RF sense subsystem 316 may perform OOK preamble and sync word/pattern detection as described herein. It should be appreciated that the RF sense subsystem 316 may remain in a wake state for transmission and receipt of RF signals while other components of the radio subsystem 312 (e.g., BLE chipset) and/or the microcontroller 300 remain unpowered or in a low power sleep state.

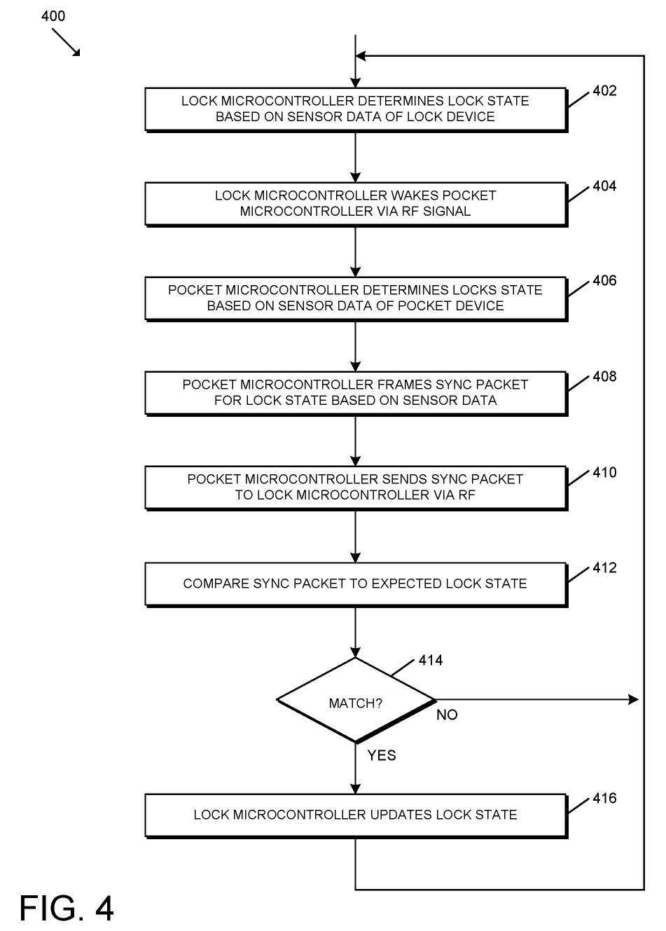

Referring now to FIG. 4, in use, the access control system 100 may execute a method 400 of leveraging low power communication within an access control system to determine a lock state. It should be appreciated that the particular blocks of the method 400 are illustrated by way of example, and such blocks may be combined or divided, added or removed, and/or reordered in whole or in part depending on the particular embodiment, unless stated to the contrary. Although the method 400 describes interactions between the lock device 102 and the pocket device 104, it should be appreciated that the method 400 could be executed, or modified, to use a different combination of access control devices in other embodiments.

The illustrative method 400 begins with block 402 in which the lock device 102 or, more specifically, the microcontroller 108 of the lock device 102 determines the lock state based on sensor data received from one or more sensors 116 of the lock device 102. For example, in some embodiments, the sensors 116 may include a deadbolt monitor and/or a latch monitor, which indicate whether the bolt/latch of the lock device 102 is in an extended position/state. In the illustrative embodiment, in block 404, the lock device 102 (e.g., the microcontroller 108) wakes the pocket device 104 or, more specifically, the microcontroller 112 of the pocket device 104 (e.g., a processor or system/module thereof) by sending a wake-up signal in response to determining that the determined lock state is indicative of a change from a first lock state to a second lock state. In other words, the lock device 102 may determine from the sensor data that the lock device 102 has transitioned from an unlocked state in which the bolt/latch is retracted to a locked state in which the bolt/latch is extended, or that the lock device 102 has transitioned from the locked state to the unlocked state, and if such a transition has occurred, the lock device 102 may generate and transmit the wake-up signal to the pocket device 104. In the illustrative embodiment, if the lock device 102 determines that no change in the lock state has occurred (e.g., the lock device 102 remains in its prior state), then the pocket device 104 remains in a low power sleep state (i.e., no wake-up signal is transmitted).

In block 406, the pocket device 104 (e.g., the microcontroller 112) determines the lock state of the lock device 102 based on sensor data received from one or more sensors 118 of the pocket device 104. For example, in some embodiments, the sensors 118 may include an inductive sensor configured to detect the presence of a bolt/latch extended into and positioned within a door strike associated with the pocket device 104. In some embodiments, if the sensors 118 detect the bolt/latch extending into and positioned within the door strike, the lock device 104 wakes or otherwise enables the RF sense subsystem, whereas in other embodiments, the RF sense subsystem is always enabled/powered. It should be appreciated that the access control system 100 can be assured that the lock device 102 is truly in a secure, locked state if both the sensors 116 of the lock device 102 and the sensors 118 of the pocket device 104 indicate that the lock device 102 is in the locked state.

In block 408, the pocket device 104 (e.g., the microcontroller 112) frames a sync packet for the lock state determined from the sensor data, and in block 410, the pocket device 104 (e.g., the microcontroller 112) sends the sync packet to the lock device 102 (e.g., the microcontroller 108) via one or more RF signals. That is, the pocket device 104 may generate and transmit a sync signal that includes data indicative of the lock state as determined by the pocket device 104 to the lock device 102. It should be appreciated that the sync signal may be encoded with the data indicative of the lock state via signal modulation. In particular, in some embodiments, the sync signal comprises an on-off keying packet that includes a sync pattern indicative of the lock state. In the illustrative embodiment, it should be appreciated that the access control system 100 may utilize a different sync pattern (e.g., OOK word/pattern) for each of the locked state and the unlocked state. For example, the access control system 100 may utilize the pattern “0xABCD” for the locked state, and the pattern “0xDCBA” for the unlocked state.

In block 412, the lock device 102 (e.g., the microcontroller 108) compares the sync packet received from the pocket device 104 to sync data stored in the memory of the lock device 102, which is indicative of an expected lock state, to determine whether the sync packet/signal matches the stored sync data. For example, in the illustrative embodiment, the lock device 102 may have an OOK pattern stored in the memory of the lock device 102, which may be compared to an OOK pattern received from the pocket device 104. If the lock device 102 (e.g., the microcontroller 108) determines, in block 414, that the sync packet/signal transmitted from the pocket device 104 matches the stored sync data, the method 400 advances to block 416. If not, the method 400 returns to block 402.

In block 416, the lock device 102 (e.g., the microcontroller 108) updates the stored sync data in the memory of the lock device 102 to reflect the new lock state. More specifically, in some embodiments, the RF sense subsystem of the microcontroller 108 of the lock device 102 may wake up a processor of the microcontroller 108 (e.g., the main processor, a processor of the radio subsystem, and/or other components of the microcontroller 108) in response to detecting the match. In some embodiments, the RF sense subsystem of the microcontroller 108 wakes other portions of the radio subsystem (e.g., a BLE module or processor thereof) via an interrupt. After waking the processor, for example, the microcontroller 108 may then update the sync pattern (e.g., OOK pattern) stored in the memory of the lock device 102 to reflect the next lock state expected to be received from the pocket device 104. For example, if this iteration of the method 400 was based on a change of the lock device 102 from an unlocked state to a locked state, the next lock state expected by the lock device 102 is the unlocked state (e.g., due to a change in the lock state from the locked state back to the unlocked state), and therefore the updated sync pattern is reflective of the expected unlocked state. Similarly, if this iteration of the method 400 was based on a change of the lock device 102 from a locked state to an unlocked state, the next lock state expected by the lock device 102 is the locked state (e.g., due to a change in the lock state from the unlocked state back to the locked state), and therefore the updated sync pattern is reflective of the expected locked state. In some embodiments, after updating the stored sync pattern, the microcontroller 108 returns to the low power sleep state in which various components of the microcontroller 108 may be powered off or in a low power mode (e.g., the main processor, a processor of the radio subsystem, and/or other components of the microcontroller 108).

Although the blocks 402-416 are described in a relatively serial manner, it should be appreciated that various blocks of the method 400 may be performed in parallel in some embodiments.

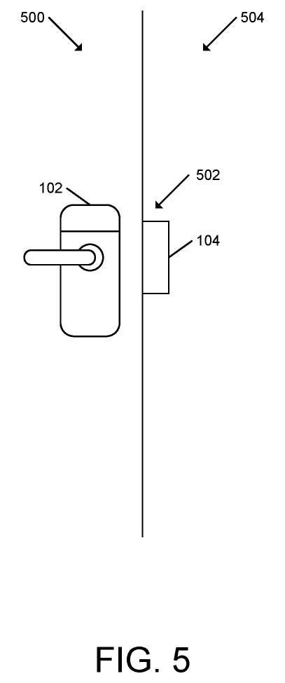

Referring now to FIG. 5, a front view of at least one embodiment of the access control system 100 of FIG. 1 depicts the lock device 102 secured to a door 500 and the pocket device 104 positioned within or forming a portion of a door strike 502 defined within the frame of a wall 504. As described above, the illustrative lock device 102 includes a lock mechanism such as a deadbolt, latch bolt, lever, and/or other mechanism that may be extended to be positioned in a locked state and retracted to be positioned in an unlocked state.

What is claimed is:

1. A method of leveraging low power communication within an access control system to determine a lock state, the method comprising:
determining, by a first access control device, a lock state of the first access control device based on sensor data received from at least one sensor of the first access control device;
transmitting, by the first access control device, a wake-up signal to a second access control device in response to determining that the lock state determined by the first access control device is indicative of a change from a first lock state to a second lock state;
waking, by the second access control device, a processor of the second access control device from a low power state in response to receiving the wake-up signal from the first access control device;
determining, by the processor of the second access control device, a lock state of the first access control device based on sensor data received from at least one sensor of the second access control device;
transmit, by the second access control device and to the first access control device, a sync signal that includes data indicative of the lock state determined by the second access control device;
determining, by the first access control device, whether sync data stored in a memory of the first access control device corresponds with the second lock state in response to receiving the sync signal; and
updating, by the first access control device, the sync data stored in the memory of the first access control device to be indicative of the first lock state in response to determining that the sync data corresponds with the second lock state.

2. The method of claim 1, wherein the at least one sensor of the first access control device comprises at least one of a deadbolt monitor or a latch monitor.

3. The method of claim 1, further comprising placing a processor of the first access control device in a sleep state in response to updating the sync data stored in the memory of the first access control device.

4. The method of claim 3, further comprising waking the processor of the first access control device from the sleep state in response to determining the sync data stored in the memory of the first access control device corresponds with the second lock state.

5. The method of claim 1, wherein the sync signal is encoded with the data indicative of the lock state via signal modulation.

6. The method of claim 1, wherein the sync signal comprises an on-off keying packet that includes a sync pattern indicative of the lock state determined by the second access control device.

7. The method of claim 1, wherein the first lock state is an unlocked state and the second lock state is a locked state.

8. The method of claim 1, wherein the first lock state is a locked state and the second lock state is an unlocked state.

9. The method of claim 1, wherein the at least one sensor of the second access control device comprises an inductive sensor.

10. The method of claim 1, wherein the first access control device comprises an electronic lock and the second access control device comprises a pocket device located at door strike pocket.

11. The method of claim 1, wherein the first access control device comprises a latch bolt configured to extend into a door strike to secure a door; and
wherein the second access control device is mechanically coupled with the door strike.

12. The method of claim 1, wherein the second access control device operates at less than one microamp of current when in the low power state.

13. An access control system for leveraging low power communication to determine a lock state, the access control system comprising:
a first access control device configured to (i) determine a lock state of the first access control device based on sensor data received from at least one sensor of the first access control device and (ii) transmit a wake-up signal to a second access control device in response to a determination that the lock state determined by the first access control device is indicative of a change from a first lock state to a second lock state; and
a second access control device configured to (i) wake a processor of the second access control device from a low power state in response to receipt of the wake-up signal from the first access control device, (ii) determine, by the processor of the second access control device, a lock state of the first access control device based on sensor data received from at least one sensor of the second access control device, and (iii) transmit, to the first access control device, a sync signal that includes data indicative of the lock state determined by the second access control device; and
wherein the first access control device is further configured to (i) determine whether sync data stored in a memory of the first access control device corresponds with the second lock state in response to receipt of the sync signal and (ii) update the sync data stored in the memory of the first access control device to be indicative of the first lock state in response to a determination that the sync data corresponds with the second lock state.

14. The access control system of claim 13, wherein the at least one sensor of the first access control device comprises at least one of a deadbolt monitor or a latch monitor.

15. The access control system of claim 13, wherein the sync signal is encoded with the data indicative of the lock state via signal modulation.

16. The access control system of claim 13, wherein the sync signal comprises an on-off keying packet that includes a sync pattern indicative of the lock state determined by the second access control device.

17. The access control system of claim 13, wherein the first lock state is an unlocked state and the second lock state is a locked state.

18. The access control system of claim 13, wherein the first lock state is a locked state and the second lock state is an unlocked state.

19. The access control system of claim 13, wherein the at least one sensor of the second access control device comprises an inductive sensor.

20. The access control system of claim 13, wherein the first access control device comprises a latch bolt configured to extend into a door strike to secure a door; and
wherein the second access control device is mechanically coupled with the door strike.
